(19) United States
(12) Patent Application Publication
(10) Pub. No.: US 2006/0233046 A1
(43) Pub. Date: Oct. 19, 2006

(54) Apparatus for effecting surveillance of a space beyond a barrier

(76) Inventors: Herbert U. Fluhler, Madison, AL (US); Larry W. Fullerton, Owens Crossroads, AL (US); Mark D. Roberts, Huntsville, AL (US); Donald D. Mondul, Dallas, TX (US)

Correspondence Address: LAW OFFICE OF DONALD D. MONDUL, 3060 Bonsai Drive, Plano, TX, 75093, US

(21) Appl. No.: 11/105,828

(22) Filed: Apr. 14, 2005

(51) Int. Cl. G03B 42/06

(52) U.S. Cl. 367/11

(57) ABSTRACT

An apparatus for effecting surveillance of a space beyond a barrier includes: (a) a plurality of sensor devices; (b) a combining unit coupled with the plurality of sensor devices; and (c) a display unit coupled with the combining unit. The combining unit receives a respective sensor signal from each respective sensor device of the plurality of sensor devices. Each respective sensor signal indicates a sensed condition in the space. The combining unit and the display unit cooperate to display at least one displayed signal representing at least one of the respective sensor signals indicating movement of an object within the space.

### CROSS REFERENCE TO RELATED APPLICATIONS

The present application is related to U.S. patent application Ser. No. ______ entitled “Apparatus for Effecting Acoustic Surveillance of a Space Beyond a Barrier,” filed 14 Apr. 2005, which is assigned to the current assignee hereof.

### BACKGROUND OF THE INVENTION

Law enforcement agencies often are confronted with hostage situations where armed intruders are barricaded inside a building. Officers on the scene generally have no means for determining the number, position and identity of persons within the building, and are thus hampered in their efforts to resolve the situation. Similarly, law enforcement personnel planning a surprise raid on an armed compound would also greatly benefit from information related to the number, position and identity of persons within the compound. Such situational awareness decreases the amount of risk faced by entering law enforcement personnel by decreasing the amount of unknowns. Furthermore, such a system would be of great use to rescue agencies attempting to find survivors in situations such as cave-ins or collapsed buildings.

Prior attempts to provide law enforcement and rescue personnel with a priori knowledge of the occupants of a structure include acoustic, optical and infrared (IR) detection systems. The acoustic solution was a passive solution using a sensitive listening device or array of listening devices to determine whether there are any sounds coming from a structure. A shortcoming of this passive acoustic approach is that determination of a position of a target emitting a sound within a structure requires a plurality of listening loci, and requires a sound source loud enough to be “heard” by the listening device or devices employed.

The optical solution requires access to the structure as through a window, a crack in the structure or creating an access into the structure such as by drilling a hole. The access must offer sufficient clearance to permit positioning a camera for surveilling the interior of the structure. Drawbacks with such an optical solution include time required for finding an access into the structure and noise created while creating or enlarging such an access. Moreover, one must keep in mind that when a camera can see a subject, the subject can also see the camera. Such is the nature of line-of-sight surveillance techniques. The camera may be made small or may be disguised, but it must still be viewable (if not noticeable) by the target if the camera can see the target.

Noise made while creating or enlarging an optical access to the interior of a structure or a target noticing the camera itself can cause surveillance or raiding personnel to lose their advantage of surprise, and may curtail or eliminate further opportunities for further surveillance. A view through an optical access such as a window, a crack or a drilled aperture may provide only a limited field of view so that parts of the interior of a structure may be hidden from optical surveillance. Smoke or opaque obstructions such as curtains, blinds, or furniture may also limit the effectiveness of optical surveillance.

Infrared (IR) detection is fundamentally a thermal mapping solution. IR cannot be reliably employed in through-wall situations. IR is generally a line-of-sight technique that suffers from the same or similar shortcomings experienced in using optical surveillance, as disclosed above.

Recent advances in communications technology have enabled an emerging, new ultra wideband (UWB) technology called impulse radio communications (hereinafter called impulse radio), which may be used in a variety of communications, radar, and/or location and tracking applications. A description of impulse radio communications is presented in U.S. Pat. No. 6,748,040B1 issued to Johnson et al. Jun. 8, 2004, and assigned to the assignee of the present invention. U.S. Pat. No. 6,748,040B1 is incorporated herein by reference.

Radar surveillance apparatuses using UWB technology have many desirable features that are advantageous in surveilling the interior of a structure not easily or thoroughly accessible using passive acoustic, optical or IR detection systems. UWB radars exhibit excellent range resolution, low processing side lobes, excellent cutter rejection capability and an ability to scan distinct range windows. The technique of time-modulated ultra wideband (TM-UWB) permits decreased range ambiguities and increased resistance to spoofing or interference. Bi-phase (i.e., polarity or “flip”) modulation offers similar and sometimes superior capabilities in these areas. Impulse radar (i.e., pulsed UWB radar) can operate using long wavelengths (i.e., low frequencies) capable of penetrating typical non-metallic construction material. Impulse radar is particularly useful in short range, high clutter environments. Thus, impulse radars are advantageously employed in environments where vision is obscured by obstacles such as walls, rubble, smoke or fire.

Various embodiments of impulse radar have been disclosed in U.S. Pat. No. 4,743,906 issued to Fullerton May 10, 1988; U.S. Pat. No. 4,813,057 issued to Fullerton Mar. 14, 1989; and U.S. Pat. No. 5,363,108 issued to Fullerton Nov. 8, 1994; all of which are assigned to the assignee of the current application. Arrays of impulse radars have been developed for such uses as high resolution detection and intruder alert systems, as disclosed in U.S. Pat. No. 6,218,979B1 issued to Barnes et al. Apr. 17, 2001; U.S. Pat. No. 6,177,903 issued to Fullerton et al. Jan. 23, 2001; U.S. Pat. No. 6,552,677B2 issued to Barnes et al. Apr. 22, 2003; U.S. Pat. No. 6,667,724 issued to Barnes et al. Dec. 23, 2003, and U.S. Pat. No. 6,614,384B2 issued to Hall et al. Sep. 2, 2003; all of which patents are assigned to the assignee of the current application. These disclosures disclose that impulse radar systems advantageously provide a low power, non-interfering surveillance capability capable of scanning through typical non-metallic building material.

A limitation of impulse radar systems is that they do not provide a scanning capability through metallic building materials. Such metallic building materials may include, for example, metallized vapor barrier material within walls, metallized window tinting material and other metal materials.

There is a need for a surveillance system that provides the advantages of impulse radar surveilling while also providing surveillance capabilities not available using an impulse radar system.

### SUMMARY OF THE INVENTION

An apparatus for effecting surveillance of a space beyond a barrier includes: (a) a plurality of sensor devices; (b) a combining unit coupled with the plurality of sensor devices; and (c) a display unit coupled with the combining unit. The combining unit receives a respective sensor signal from each respective sensor device of the plurality of sensor devices. Each respective sensor signal indicates a sensed condition in the space. The combining unit and the display unit cooperate to display at least one displayed signal representing at least one of the respective sensor signals.

It is therefore an object of the present invention to provide a surveillance system that provides the advantages of impulse radar surveilling while also providing surveillance capabilities not available using an impulse radar system

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram of the apparatus of the present invention employed to surveil a space beyond a barrier.

FIG. 2 is a schematic diagram of a preferred embodiment of the present invention configured for employing a passive sensor technology.

FIG. 3 is a schematic diagram of a preferred embodiment of the present invention configured for employing an active sensor technology.

FIG. 4 is a schematic diagram of a preferred embodiment of the present invention configured for employing a plurality of sensor technologies.

FIG. 5 is a schematic diagram of a preferred embodiment of the present invention configured for employing UWB position determination technology in conjunction with dispersed sensors to enable correlation of sensor information.

### DETAILED DESCRIPTION OF THE PREFERRED EMBODIMENT

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

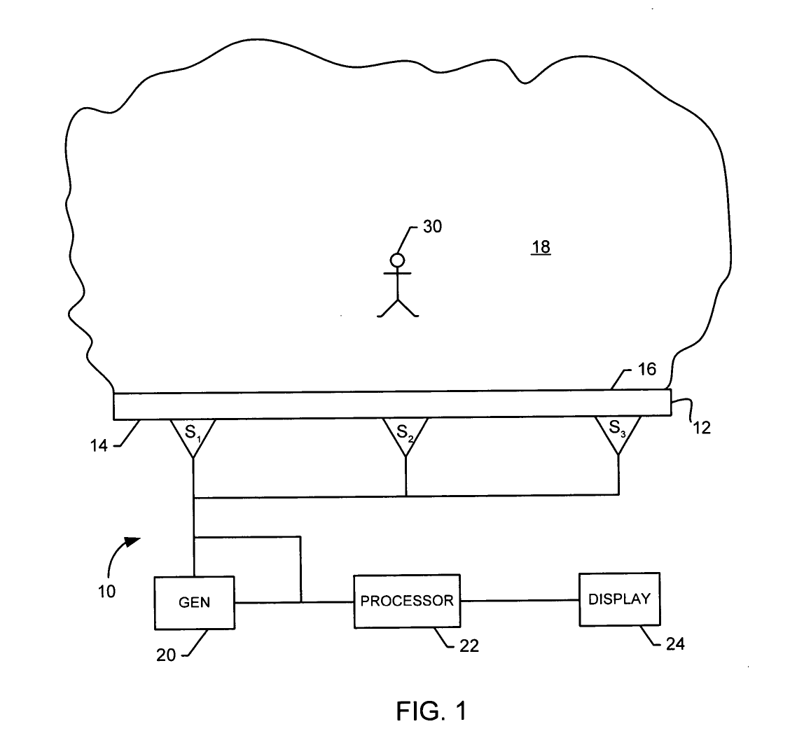

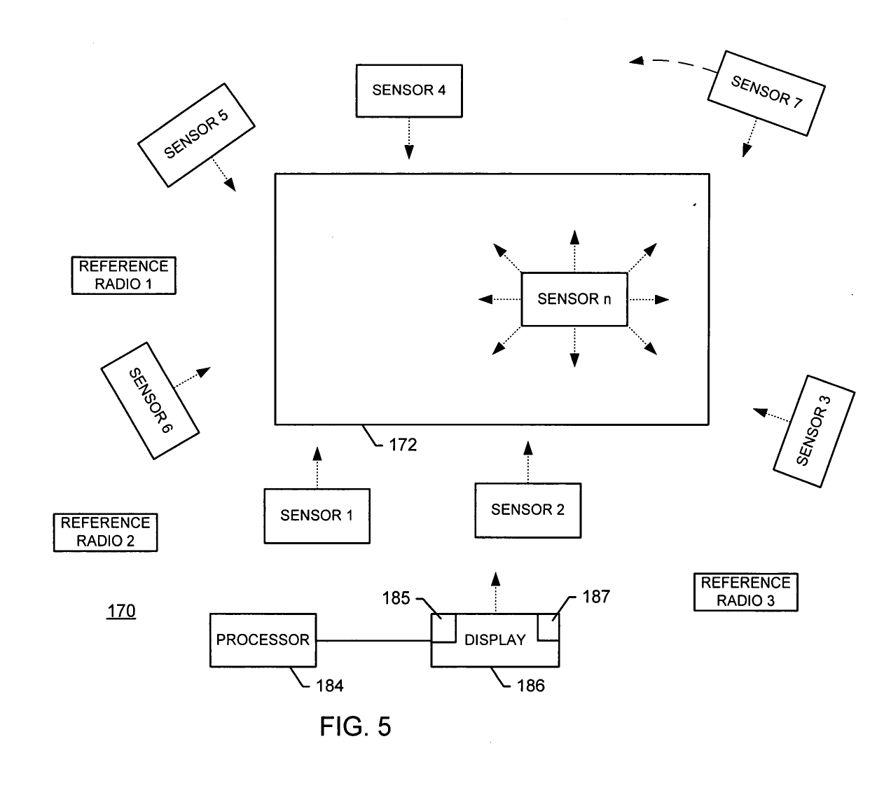

FIG. 1 is a schematic diagram of the apparatus of the present invention employed to surveil a space beyond a barrier. In FIG. 1, a surveillance apparatus 10 is arrayed substantially adjacent to a barrier 12. Surveillance apparatus 10 may be located in any orientation with respect to a surveilled space 18 at any distance from barrier 12. However, it is preferred that apparatus 10 be oriented in a substantially abutting relation with a first side 14 of barrier 12 to effect surveillance of space 18 adjacent to a second side 16 of barrier 12. Surveillance apparatus 10 includes at least one sensor unit, represented by sensor units S₁, S₂, S₃, where sensor units S₁, S₂, S₃ may be embodied in a greater number than three. Sensor units S₁, S₂, S₃ may be located in any convenient arrangement with respect to space 18, including in surrounding relation about space 18. Such a surrounding relation of sensor units S₁, S₂, S₃ about space 18 advantageously provides a plurality of look angles at targets within space 18. In such a dispersed surrounding arrangement, sensor units S₁, S₂, S₃ may communicate with a signal generator 20, a processor unit 22 and a display unit 24 via any of various physical (shown) or wireless network configurations (not shown in FIG. 1), including a wireless local area network (WLAN). Under one arrangement, the relative locations and look angles of the sensor units are known relative to the location and look angle of the display enabling sensor information to be correlated. For example, sensors may be installed into a building infrastructure at known relative locations and their look angles carefully calibrated relative to that of an information display. Under another arrangement, the relative locations and look angles of the sensors and display are determined at time of sensing thereby enabling the information from the dispersed sensors to be properly correlated. An example of such an arrangement is described later in relation to FIG. 5.

In another embodiment, surveillance apparatus 10 is configured for easy portable use with sensor units S₁, S₂, S₃ mounted in a unitary arrangement for locating substantially adjacent to barrier 12. Such an arrangement would constitute a physical unitary sensor array.

Alternatively, sensor units S₁, S₂, S₃ may be regarded as representing a single sensor unit being relocated at three sites S₁, S₂, S₃ at different times. Such an arrangement would constitute a synthetic aperture array.

The preferred embodiment of surveillance apparatus 10 provides a plurality of sensor units S₁, S₂, S₃ unitarily mounted substantially adjacent to barrier 12 for locating targets in space 18. Sensor units S₁, S₂, S₃ are coupled with signal generator 20 and coupled with processor unit 22. Processor unit 22 is coupled with display unit 24. Processor unit 22 may be embodied in any intelligent apparatus, including by way of example and not by way of limitation, a microprocessor apparatus, a computer apparatus, an interface apparatus conveying commands and instructions from a remote location via a wireless or network connection (e.g., a local area network, wide area network, the Internet or another network) or a similarly capable intelligent apparatus.

Sensor units S₁, S₂, S₃ may include an active (transmitting) element and a passive (receiving) element (not shown in detail in FIG. 1). Thus, each of sensor elements S₁, S₂, S₃, may be embodied, by way of example and not by way of limitation, in an active transmitting element and a companion passive receiving element. One or more active elements and/or passive elements may be omni-directional.

Generator 20 responds to processor unit 22 for driving sensor units S₁, S₂, S₃ to transmit a signal using a particular technology, such as acoustic technology. At least one sensor unit S₁, S₂, S₃ may include an omnidirectional transmitter device, an omnidirectional receiver (transducer) device or omnidirectional transmitter and receiver (transducer) devices. Other technologies may be employed with surveillance apparatus 10 including by way of example and not by way of limitation, electromagnetic technology including UWB signaling technology, infrared or other optical technology (provided barrier 12 may be breached as by an aperture or crack; not shown in FIG. 1), x-ray technology (including x-ray backscatter technology).

A first sensor S₁ transmits a signal through barrier 12 into space 18. Then a second sensor S₂ transmits a signal through barrier 12 into space 18, or in the alternative, first sensor S₁ is moved to a position S₂ and then transmits a signal through barrier 12 into space 18. Then a third sensor S₃ transmits a signal through barrier 12 into space 18, or in the alternative, first sensor S₁ is moved to a position S₃ and then transmits a signal through barrier 12 into space 18. A return signal returned from a person or target 30 in space 18 is detected by each of sensor units S₁, S₂, S₃ and the return signals are provided to processor unit 22. Processor unit 22 combines return signals received from sensor units S₁, S₂, S₃ and presents a composite signal to display unit 24 for display to a user indicating location of target 30 in space 18. Alternatively, display unit 24 may display more than one signal to a user. The combining carried out by processing unit 22 may be effected in any of a variety of ways or a combination of a variety of ways. By way of example and not by way of limitation, processing unit 22 may combine return signals received from sensor units S₁, S₂, S₃ by weighting signals according to predetermined criteria, including criteria provided by a user. A user may indicate criteria directly to processor unit 22 or a user may indicate other parameters to processor unit 22, such as weather conditions, building materials in barrier 12, ambient noise conditions and similar environmental characteristics, and processor unit 22 may employ such environmental indications provided by a user to develop or derive proper algorithmic conditions to implement those environmental indications in combining return signals received from sensor units S₁, S₂, S₃.

Surveillance unit 10 may also be employed in an acoustic mode. In an acoustic mode, sensor units S₁, S₂, S₃ may be mounted in a unitary arrangement for locating substantially adjacent to barrier 12, or sensor units S₁, S₂, S₃ may be regarded as representing a single sensor unit S being relocated at three sites S₁, S₂, S₃. Additional sensor elements, especially signal receiver elements would need to be placed at other boundaries of space 18, such as at other boundary walls (not shown in FIG. 1). Preferably all sensor units S₁, S₂, S₃ and sensor units at other boundaries of space 18 are placed at the floor juncture of boundary 12 (not shown in detail in FIG. 1). Acoustic signals generated by sensor units S₁, S₂, S₃ may be propagated through the floor of space 18 (not shown in detail in FIG. 1) in an acoustic wave. Target 30, standing on the floor of space 18 interrupts acoustic waves propagating through the floor of space 18. Sensor units at other boundary walls of space 18 receive acoustic signals and pass the received acoustic signals to processor unit 22 (connection not shown in detail in FIG. 1). Processor unit 22 may evaluate received acoustic signals from sensor units at other boundary walls of space 18 to ascertain the location of target 30 in two dimensions.

In situations where active acoustic signaling is employed, it is advantageous to transmit acoustic signals that are substantially outside the range of human hearing in order to avoid alerting subjects in space 18 that they are under surveillance. Alternatively, acoustic signals may be configured to imitate commonly occurring sounds in the environment being surveilled, such as sounds of a refrigerator compressor, an aircraft, or other sounds that are unlikely to alert persons in space 18 that they are under surveillance. Acoustic signals may be encoded to sound like noise, such as for example, using pseudo random number coding. Acoustic signals may also be made from noise such as white noise or colored noise.

Further, when employing active or passive acoustic sensor techniques, a voice discrimination or identification capability can be employed by processor unit 46 to permit distinction of one target 30 among a plurality of occupants of space 18 by relating distinguishing voice characteristics of respective targets to their determined locations within space 18. Still further, if processor unit 22 is provided with voiceprints of particular individuals, such as kidnapping suspects, voice identification information received by sensor units S₁, S₂, S₃ may be compared in processor unit 22 with known suspects' voiceprints such the identification of occupants of space 18 may be affected in relation to their determined locations. Such information can be used for discriminating the locations of criminal suspects from the locations of innocent persons.

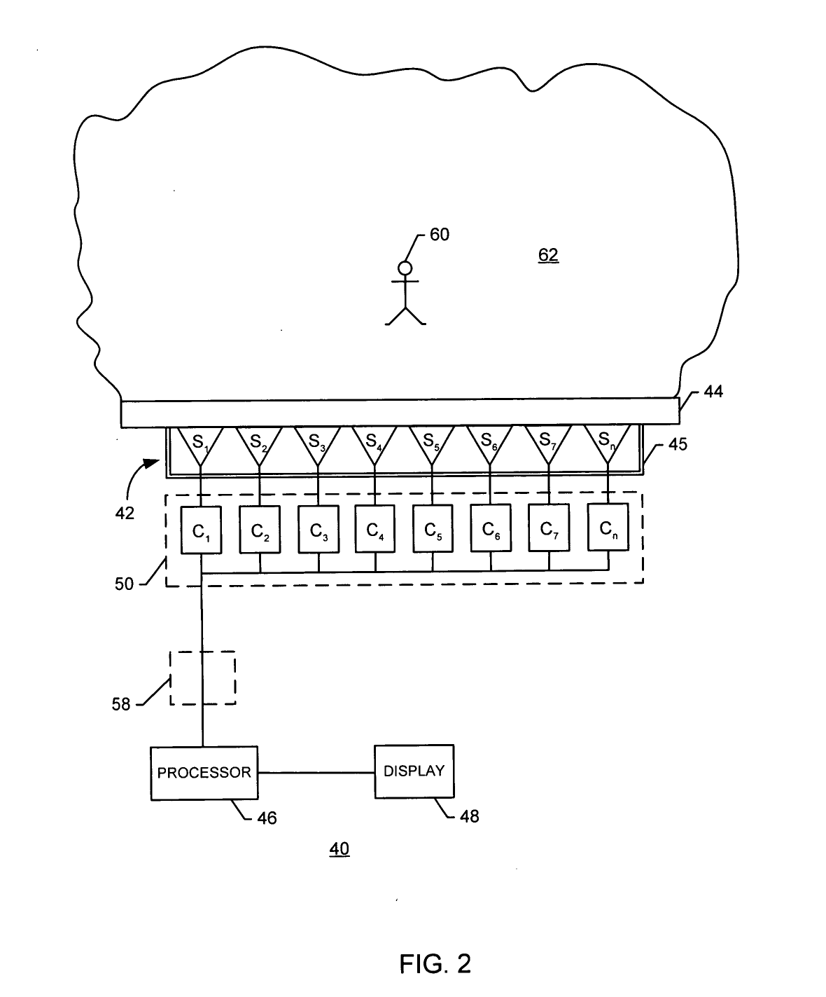

FIG. 2 is a schematic diagram of a preferred embodiment of the present invention configured for employing a passive sensor technology. In FIG. 2, a surveillance unit 40 includes a sensor element array 42 mounted in a unitary arrangement for locating substantially adjacent to barrier 44. Sensor element array 42 is coupled with a processor unit 46. Processor unit 46 is coupled with display unit 48. Processor unit 46 may be embodied in any intelligent apparatus, including by way of example and not by way of limitation, a microprocessor apparatus, a computer apparatus, an interface apparatus conveying commands and instructions from a remote location via a wireless or network connection (e.g., a local area network, wide area network, the Internet or another network) or a similarly capable intelligent apparatus.

Sensor element array 42 includes a plurality of sensor elements {S₁, . . . , Sₙ}. Sensor elements {S₁, . . . , Sₙ} may be embodied, by way of example and not by way of limitation, in omni-directional microphone devices or embodied in directional microphone devices.

The indicator “n” is employed throughout this specification to signify that there can be any number of elements in an element array. In certain examples of element arrays, “n” is 8. However, “n” equaling 8 is illustrative only and does not constitute any limitation regarding the number of elements that may be included in an element array of the surveillance apparatus of the present invention.

Sensor element array 42 is controlled by a control array 50. Control array 50 includes a plurality of control units {C₁, . . . , Cₙ} where control unit C₁ controls operation of sensor unit S₁, control unit C₂ controls operation of sensor unit S₂, and so on. Alternatively, all of sensors {S₁, . . . , Sₙ} may be controlled by a single control unit 58, as indicated in dotted line format in FIG. 2. The preferred embodiment of surveillance apparatus 40 provides sensor units {S₁, . . . , Sₙ} unitarily mounted for locating substantially adjacent to barrier 44.

Sound signals generated by a target 60 are detected by each of sensor units {S₁, . . . , Sₙ} and the sound signals are provided to processor unit 46. Control units {C₁, . . . , Cₙ} preferably cooperate to ensure that only one of sensor units {S₁, . . . , Sₙ} at a time passes information relating to sound detected in space 62 beyond barrier 44. Processor unit 46 combines sound signals received from sensor units {S₁, . . . , Sₙ} and presents a composite signal to display unit 48 for display to a user indicating location of target 60 in space 62. A sound-reducing barrier 45 preferably surrounds sensor elements {S₁, . . . , Sₙ} to reduce the effects of ambient noise on sensor elements. Reducing effects of ambient noise helps to ensure that return signals provided from sensor elements {S₁, . . . , Sₙ} to processor 46 accurately represent conditions in space 62. Sound-reducing barrier 45 is useful when sensor elements {S₁, . . . , Sₙ} are omni-directional in that the sound-reducing barrier reduces sensitivity of sensor elements {S₁, . . . , Sₙ} to sounds occurring adjacent to sensor elements {S₁, . . . , Sₙ} while not inhibiting sensitivity of sensor elements {S₁, . . . , Sₙ} in directions toward a surveilled space.

The combining carried out by processor unit 46 may be effected in any of a variety of ways or in a combination of a variety of ways. By way of example and not by way of limitation, processor unit 46 may combine return signals received from sensor units {S₁, . . . , Sₙ} by weighting signals according to predetermined criteria, including criteria provided by a user. A user may indicate criteria directly to processor unit 46 or a user may indicate other parameters to processor unit 46, such as weather conditions, building materials in barrier 44, ambient noise conditions and similar environmental characteristics. Processor unit 46 may employ such environmental indications provided by a user to develop or derive proper algorithmic conditions to implement those environmental indications in combining return signals received from sensor units {S₁, . . . , Sₙ}.

The relative times at which return signals arrive at two or more of sensor units can be used to determine the position of target 60 using any one of well known techniques including Time Difference of Arrival (TDOA), beamforming, maximum likelihood, Markov chain Monte Carlo, etc. Return signal timing and magnitude can also be used to determine movement, size, velocity, and reflectivity of a target. Advanced signal processing techniques can also be used for more precise target discrimination so as to, for example, differentiate a man from a dog, determine presence of a weapon, etc.

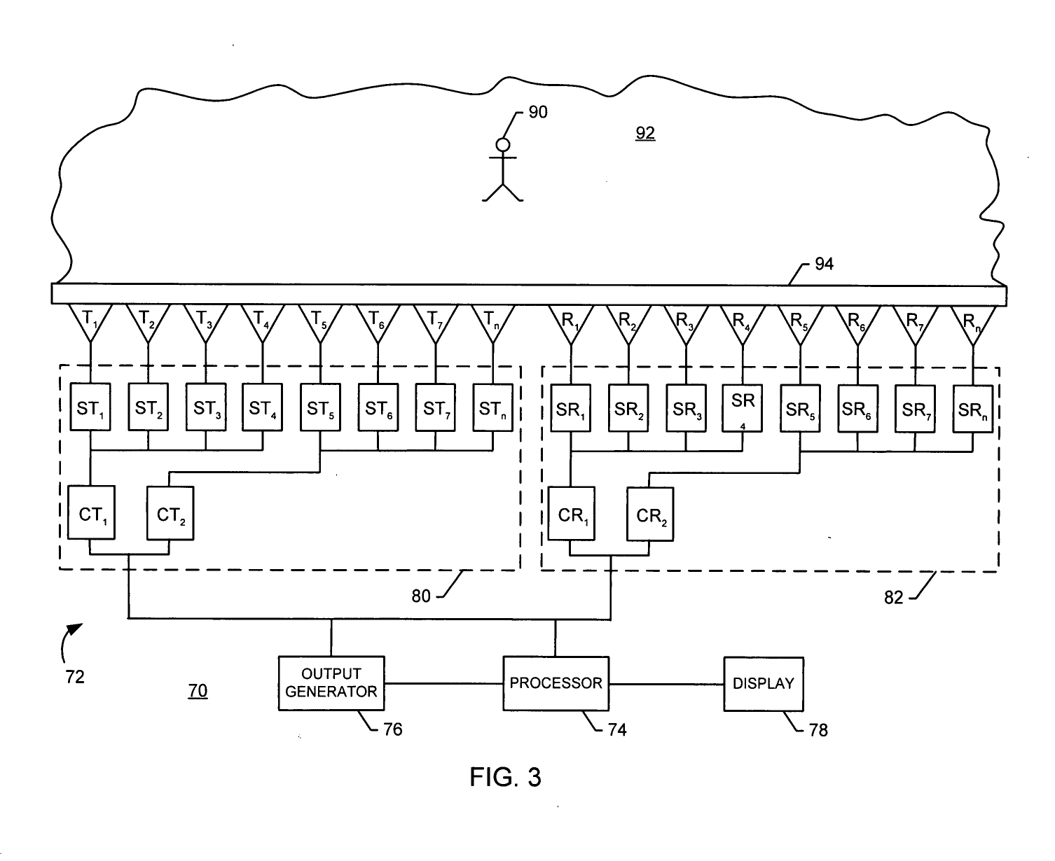

FIG. 3 is a schematic diagram of a preferred embodiment of the present invention configured for employing an active sensor technology. In FIG. 3, a surveillance unit 70 includes a sensor element array 72 having a plurality of transmit elements {T₁, . . . , Tₙ} and having a plurality of receive elements {R₁, . . . , Rₙ}. Transmit elements {T₁, . . . , Tₙ} and receive elements {R₁, . . . , Rₙ} are preferably mounted in a unitary arrangement for locating substantially adjacent to a barrier (not shown in FIG. 3). Alternatively, transmit elements {T₁, . . . , Tₙ} and receive elements {R₁, . . . , Rₙ} may be located at separate loci, not in a single unitary arrangement (not shown in FIG. 3). In still another arrangement, one or more transmit/receive switches are employed enabling the same elements to be used for both transmitting and receiving.

Sensor element array 72 is controlled by control arrays 80, 82 in response to a processor unit 74. Control array 80 includes a plurality of transmit element switch units {ST₁, . . . , STₙ}, where transmit element switch unit ST₁ controls operation of transmit element T₁, transmit element switch unit ST₂ controls operation of transmit element T₂, and so on.

Transmit elements {T₁, . . . , Tₙ} are arranged in a first transmit element group T₁, T₂, T₃, T₄ and a second transmit element group T₅, T₆, T₇, Tₙ. Depending on the value of “n”, different numbers of transmit elements may be included in transmit element groups and/or additional transmit element groups may be employed. First transmit element group T₁, T₂, T₃, T₄ is coupled with a first transmit row switch controller CT₁. Second transmit element group T₅, T₆, T₇, Tₙ is coupled with a second transmit row switch controller CT₂.

Control array 82 includes a plurality of receive element switch units {SR₁, . . . , SRₙ}. Receive element switch unit SR₁ controls operation of receive element R₁, receive element switch unit SR₂ controls operation of receive element R₂, and so on.

Receive elements {R₁, . . . , Rₙ} are arranged in a first receive element group R₁, R₂, R₃, R₄ and a second receive element group R₅, R₆, R₇, Rₙ. Depending on the value of “n”, different numbers of receive elements may be included in receive element groups and/or additional receive element groups may be employed. First receive element group R₁, R₂, R₃, R₄ is coupled with a first receive row switch controller CR₁. Second transmit element group R₅, R₆, R₇, Rₙ is coupled with a second receive row switch controller CR₂.

Transmit row switch controllers CT₁, CT₂ and receive row switch controllers CR₁, CR₂ are coupled with a processor unit 74 and an output generator 76. Processor unit 74 is coupled with a display unit 48. Sensor element array 72 may be embodied in a plurality of sets of transmit elements {T₁, . . . , Tₙ} and receive elements {R₁, . . . , Rₙ preferably arranged in substantially parallel rows. Only a single row of transmit elements {T₁, . . . , Tₙ} and receive elements {R₁, . . . , Rₙ} is illustrated in FIG. 3 in order to simplify explaining the invention.

Transmit row switch controllers CT₁, CT₂, receive row switch controllers CR₁, CR₂ and output generator 76 respond to processor unit 74 to effect surveillance of a space beyond a barrier (not shown in FIG. 3) against which surveillance unit 70 is placed. Processor unit 74 may be embodied in any intelligent apparatus, including by way of example and not by way of limitation, a microprocessor apparatus, a computer apparatus, an interface apparatus conveying commands and instructions from a remote location via a wireless or network connection (e.g., a local area network, wide area network, the Internet or another network) or a similarly capable intelligent apparatus. Processor unit 74 controls output generator 76 in generating an output signal for transmission by transmit elements {T₁, . . . , Tₙ}. Processor unit 74 also controls transmit row switch controllers CT₁, CT₂, receive row switch controllers CR₁, CR₂ to ensure that transmissions by surveillance apparatus 70 do not interfere with each other and do not interfere with signals received by surveillance apparatus 70. Transmit row switch controllers CT₁, CT₂, receive row switch controllers CR₁, CR₂ respond to processor unit 74 to control whether transmission by surveillance apparatus 70 is effected via first transmit element group T₁, T₂, T₃, T₄ and a second transmit element group T₅, T₆, T₇, Tₙ and further control which of transmit elements {T₁, . . . , Tₙ} is employed for effecting a particular transmission ordered by processor unit 74. Transmissions may be effected in any of a particular active sensor technology such as, by way of example and not by way of limitation, electromagnetic technology including UWB radio frequency technology, millimeter wave technology and terahertz technology; acoustic technology including UWB acoustic technology, ultrasonic technology, and acoustic wave technology; thermal technology including infrared (IR) technology; x-ray technology including x-ray backscatter technology and other technologies useful for surveillance operations.

Receive row switch controllers CR₁, CR₂ are responsive to processor unit 74 to assure proper sampling of receive elements {R₁, . . . , Rₙ} for detecting changes caused to transmitted signals by presence of a target 90 in a target space 92 beyond a barrier 94. Processor unit 74 treats received signals to ascertain certain aspects of a target 90 in a target space 91. Aspects ascertained may include, by way of example and not by way of limitation, position, movement, identification, distinction from other targets and other aspects. Some aspects are better determined using one surveillance technology than when using another technology. Determination of some aspects may be improved using more than one surveillance technology and combining results gleaned from return signals of at least two of the more than one surveillance technology. Signal treatment by processor unit 74 may be carried out, by way of example and not by way of limitation, using synthetic aperture radar technology, amplitude stacking technology, waveform stacking technology and interferometry technology. Amplitude stacking and wave form stacking involve simply adding amplitudes or waveforms together to produce a resultant composite signal. Signal treating may include weighting of signals received by processor unit 74. Weighting may be effected, by way of example and not by way of limitation, by algorithmically weighting signals from each of receive elements {R₁, . . . , Rₙ} according to one or more of reliability of signals, strength of signals, quality of signals and continuity of signals received by processor unit 74 from each respective receive element {R₁, . . . , Rₙ}.

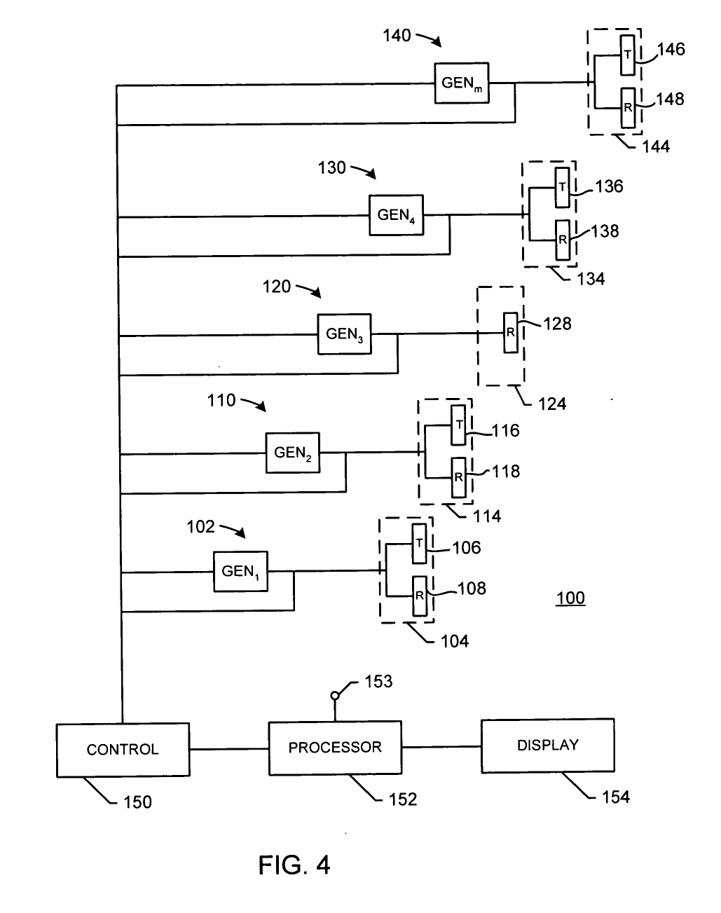

FIG. 4 is a schematic diagram of a preferred embodiment of the present invention configured for employing a plurality of sensor technologies. In FIG. 4, a surveillance apparatus 100 includes surveillance units 102, 110, 120, 130, 140. Surveillance unit 102 is preferably configured similarly to surveillance unit 70 (FIG. 3) and has a sensor device 104 and an output generator GEN₁. Sensor device 104 includes a transmit section 106 and a receive section 108. Output generator GEN₁ is coupled with a control unit 150. Transmit section 106 and receive section 108 are coupled with output generator GEN₁ and coupled with control unit 150.

Surveillance unit 110 is preferably configured similarly to surveillance unit 70 (FIG. 3) and has a sensor device 114 and an output generator GEN₂. Sensor device 114 includes a transmit section 116 and a receive section 118. Output generator GEN₂ is coupled with control unit 150. Transmit section 116 and receive section 118 are coupled with output generator GEN₂ and coupled with control unit 150.

Surveillance unit 120 is preferably configured similarly to surveillance unit 40 (FIG. 2) and has a sensor device 124 and an output generator GEN₃. Sensor device 124 includes a receive section 118. Output generator GEN₃ is coupled with control unit 150. Receive section 118 is coupled with output generator GEN₃ and coupled with control unit 150.

Surveillance unit 130 is preferably configured similarly to surveillance unit 70 (FIG. 3) and has a sensor device 134 and an output generator GEN₄. Sensor device 134 includes a transmit section 136 and a receive section 138. Output generator GEN₄ is coupled with control unit 150. Transmit section 136 and receive section 138 are coupled with output generator GEN₄ and coupled with control unit 150.

Surveillance unit 140 is preferably configured similarly to surveillance unit 70 (FIG. 3) and has a sensor device 144 and an output generator GENₘ. Sensor device 144 includes a transmit section 146 and a receive section 148. Output generator GENₘ is coupled with control unit 150. Transmit section 146 and receive section 148 are coupled with output generator GENₘ and coupled with control unit 150.

The indicator “m” is employed to signify that there can be any number of sensor devices in surveillance apparatus 100. The inclusion of five sensor devices 102, 110, 120, 130, 140 in FIG. 4 is illustrative only and does not constitute any limitation regarding the number of sensor devices that may be included in the surveillance apparatus of the present invention.

Sensor devices 102, 110, 120, 130, 140 may be located in any convenient arrangement with respect to a surveilled space (not shown in FIG. 4), including in surrounding relation about a surveilled space. Such a surrounding relation of sensor devices 102, 110, 120, 130, 140 about a surveilled space advantageously provides a plurality of look angles at targets within a surveilled space. In such a dispersed surrounding arrangement, sensor devices 102, 110, 120, 130, 140 may communicate with control unit 150 via any of various physical and network configurations (not shown in FIG. 4), including a wireless local area network (WLAN). Sensor devices 102, 110, 120, 130, 140 may be configured for effecting UWB locating techniques for locating each respective sensor device 102, 110, 120, 130, 140 and control unit 150. Other locating devices and technologies, such as compasses, gyroscopes, location beacons, satellite locating, GPS (Global Positioning System) and other locating technologies may be employed singly or in combinations to establish locations and look orientations of sensor devices 102, 110, 120, 130, 140. Such locating and orientation information may be used by apparatus 100 for presenting a combined unified display incorporating sensing data from each of sensor devices 102, 110, 120, 130, 140. Establishing location, or orientation or location and orientation of respective sensor devices 102, 110, 120, 130, 140 permits establishing an ad hoc reference grid with respect to sensor devices 102, 110, 120, 130, 140 for use in defining locations within or without a surveilled space. Sensor devices 102, 110, 120, 130, 140 may be embodied in a greater number than three. Sensor devices 102, 110, 120, 130, 140 may be situated at any of several vertical heights and thereby contribute to a three dimensional display of a surveilled area.

By way of further example and not by way of limitation, if one or more of sensor devices 102, 110, 130, 140 is embodied in a radar surveillance device, the transmit portion and receive portion of the radar device may be located separately (i.e., bistatic radar devices), or the transmit portion and receive portion of the radar device may be co-located (i.e., monostatic radar devices) or both bistatic and monostatic radar devices may be employed in apparatus 100. In another embodiment, surveillance apparatus 100 is configured for easy portable use with sensor devices 102, 110, 120, 130, 140 mounted in a unitary arrangement for locating substantially adjacent to barrier 12.

Apparatus 100 or its individual sensor devices 102, 110, 120, 130, 140 maybe located in a standoff position remote from a surveilled space, may be mounted on a robot (either stationary or moving), or may be carried by another moving platform or person.

Sensor devices 102, 110, 130, 140 are configured for employment of active surveillance technologies requiring transmission of a signal into a surveilled space and detection of return signals from the surveilled space. As mentioned earlier herein, sensor devices 102, 110, 130, 140 are preferably configured similarly to surveillance unit 70 (FIG. 3) and can advantageously employ active surveillance technologies such as, by way of example and not by way of limitation, UWB electromagnetic technology, acoustic technology (which may involve UWB acoustic technology), infrared (IR) illuminating technology, x-ray technology (including x-ray backscatter technology), surface acoustic wave technology and other active technologies useful for surveillance operations.

Sensor device 120 is configured for employment of passive surveillance technologies requiring detection of signals from a surveilled space. As mentioned earlier herein, sensor device 120 is preferably configured similarly to surveillance unit 40 (FIG. 2) and can advantageously employ active surveillance technologies such as, by way of example and not by way of limitation, acoustic, infrared (also sometimes referred to as thermal) and millimeter wave technologies. While only one passive sensor device 120 is illustrated in FIG. 4, more than one passive sensor device may be included in surveillance apparatus 100 without departing from the spirit and scope of the present invention.

Control unit 150 is coupled with a processor unit 152, and processor unit 152 is coupled with a display unit 154. Processor unit 152 may be embodied in any intelligent apparatus, including by way of example and not by way of limitation, a microprocessor apparatus, a computer apparatus, an interface apparatus conveying commands and instructions from a remote location via a wireless or network connection (e.g., a local area network, wide area network, the Internet or another network) or a similarly capable intelligent apparatus.

Received signals passed from sensor devices 102, 110, 120, 130, 140 to control unit 150 may be pretreated or processed by control unit 150 to ease the processing load on processor unit 152. Preferably, all signals passed from sensor devices 102, 110, 120, 130, 140 are provided by control unit 150 to processor unit 152 without treatment. Processor unit 152 may be included integrally within display unit 154, if desired. Alternatively, control unit 150, processor unit 152 and display unit 154 may be embodied in a single integral unit with shared or distributed intelligence. However configured, control unit 150, processor unit 152 and display unit 154 cooperate to display at least one displayed signal at display unit 154 that represents at least one of the received signals passed from sensor devices 102, 110, 120, 130, 140 to control unit 150. At least one of control unit 150, processing unit 152 and display unit 154 preferably scales the various received signals passed from sensor devices 102, 110, 120, 130, 140 to ensure that the display presented at display unit 154 is meaningful and accurately represents sensed conditions in the surveilled space.

Processor unit 152 preferably permits input, represented as an input pin 153, to indicate the environment in which surveillance unit 100 is employed. By way of example and not by way of limitation, processor unit 152 may combine return signals received from sensor devices 102, 110, 120, 130, 140 by weighting signals according to predetermined criteria, including criteria provided by a user. A user may indicate criteria directly to processor unit 152 via input pin 153. Alternatively, instead of requiring a user to directly make algorithmic changes to handling of signals by processor unit 152, processor unit 152 may be configured with a program or other logical signal treatment capability to determine proper algorithmic treatment of received signals. Such a program permits a user to indicate observable parameters to processor unit 152, such as weather conditions, building materials in a barrier, absence of a barrier (indicating likelihood that certain passive sensor technologies may be more reliable than when a barrier is present), ambient noise conditions and similar environmental characteristics. Processor unit 152 may employ its included program to evaluate the user-provided environmental indications to develop or derive proper algorithmic conditions to accommodate those environmental indications in combining return signals received from sensor devices 102, 110, 120, 130, 140. The algorithmic conditions may include, by way of example and not by way of limitation, proper weighting of various return signals received from sensor devices 102, 110, 120, 130, 140.

Control unit 150 may cause sensor devices 102, 110, 120, 130, 140 to operate simultaneously in so far as the various surveillance technologies employed by sensor devices 102, 110, 120, 130, 140 do not mutually interfere. In the alternative, other employment scheduling of sensor devices 102, 110, 120, 130, 140 may be employed including time interleaving so that operating periods of some of sensor devices 102, 110, 120, 130, 140 occur between operating periods of other of sensor devices 102, 110, 120, 130, 140. Interleaving may result in operation of some of sensor devices 102, 110, 120, 130, 140 during periods overlapping operating periods of other of sensor devices 102, 110, 120, 130, 140. Such operation may or may not be entirely simultaneous. Other timing schemes are also possible, including operating some sensor devices more often than other sensor devices, or operating some sensor devices for longer periods than other sensor devices or changing operating timing patterns among various sensor devices over time.

Display unit 154 may display a single weighted and combined signal indicating conditions in a surveilled space. Alternatively, display unit 154 may display a plurality of signals. The signals may be individually indicating various return signals received from sensor devices 102, 110, 120, 130, 140, or may be signals indicating sub-combinations of various return signals. Providing more signals may permit an operator or user to exercise a greater human control over how various return signals received from sensor devices 102, 110, 120, 130, 140 should be weighted or otherwise considered. Surveillance apparatus 10 may be configured to permit a user to manually select one or more of sensor devices 102, 110, 120, 130, 140, and manually select how return signals from sensor devices 102, 110, 120, 130, 140 are to be displayed. Display unit 154 may be embodied in a plurality of display units, each respective display unit of the plurality of display units displaying the same signal or displaying different signals.

It is preferred that surveillance apparatus 100 be configured for hand-held operation by an operator.

As described previously in relation to FIG. 1, multiple sensors may be dispersed at different locations and having different look angles relative to a display. Various locating devices and technologies, such as compasses, gyroscopes, location beacons, satellite locating, GPS (Global Positioning System) and other locating technologies may be employed singly or in combinations to establish locations and look orientations of dispersed sensor units.

FIG. 5 is a schematic diagram of a preferred embodiment of the present invention configured for employing UWB position determination technology in conjunction with dispersed sensors to enable correlation of sensor information. Various UWB position determination techniques are described in U.S. Pat. No. 6,111,536 issued to Richards et al. Aug. 29, 2000; U.S. Pat. No. 6,133,876 issued to Fullerton et al. Oct. 17, 2000; and U.S. Pat. No. 6,300,903 issued to Richards et al. Oct. 9, 2001, which are incorporated herein by reference. In FIG. 5, sensor 1 through sensor n are depicted at locations in and around a surveilled area 172 such as a building. At a given time, a given sensor 1-n may be stationary or moving. Each of sensors 1-n can comprise any of various types of sensors described herein such as a UWB radar sensor or other non-UWB sensor types. Each of sensors 1-n includes a UWB radio enabling UWB communications capabilities and UWB position determination techniques to be used to determine the position of each of sensor 1-n relative to reference UWB radios 1-3. Three reference UWB radios 1-3 are used as an example. At least two reference UWB radios are needed to determine a two-dimensional position, where ambiguities may be eliminated based on a priori knowledge. Four reference UWB radios, where at least one reference radio is at a different elevation as the others, can determine a three-dimensional position. A display 186 is augmented with an UWB radio such that position of display 186 relative to sensors 1-n can be determined. Relative look angles (or perspectives) of sensors 1-n and of display 186 are depicted in FIG. 5 using dashed lines with arrows associated with each of the various devices. For certain types of sensors such as certain acoustic sensors, information may be received omnidirectionally as is illustratively depicted with sensor n. In contrast, other types of sensors than acoustic sensors may sense information relative to a given direction. Various methods can be used to measure relative look angles. In FIG. 5, by way of example and not by way of limitation, sensors 1-n and display 186 each may include a compass and a gyroscope whereby the look angle and direction of the device are determined. A compass 185 and a gyroscope 187 are illustratively included in display 186 in FIG. 5. As shown in FIG. 5, display 186 receives sensor, directional, and position information via UWB communications from sensors 1-n and/or reference UWB radios 1-3. Information received by display 186 is processed by a processor 184. Processor 184 correlates (i.e., translates and overlays) the information from sensors 1-n to present a combined unified display at display 186. Generally, the dispersion of sensors 1-n and display 186 permit establishing an ad hoc reference grid for use in defining locations within or without surveilled area 172. Sensors 1-n may be situated at any of several vertical heights and thereby contribute to a three dimensional display of surveilled area 172.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for effecting surveillance of a space beyond a barrier; the apparatus comprising:
(a) a plurality of sensor devices;
(b) a combining unit coupled with said plurality of sensor devices; and
(c) a display unit coupled with said combining unit;
said combining unit receiving a respective sensor signal from each respective sensor device of said plurality of sensor devices; each said respective sensor signal indicating a sensed condition in said space; said combining unit and said display unit cooperating to display at least one displayed signal representing at least one of said respective sensor signals.

2. An apparatus for effecting surveillance of a space beyond a barrier as recited in claim 1 wherein said combining unit effects scaling of at least one said respective sensor signal substantially to a common scale for use in said at least displayed signal.

3. An apparatus for effecting surveillance of a space beyond a barrier as recited in claim 1 wherein said display unit effects scaling of at least one said respective sensor signal substantially to a common scale for use in said at least one displayed signal.

4. An apparatus for effecting surveillance of a space beyond a barrier as recited in claim 1 wherein at least one sensor device of said plurality of sensor devices employs at least one sensing technology among thermal technology, acoustic technology, electromagnetic technology and x-ray technology.

5. An apparatus for effecting surveillance of a space beyond a barrier as recited in claim 4 wherein said thermal technology includes at least one of infrared technology and millimeter wave technology.

6. An apparatus for effecting surveillance of a space beyond a barrier as recited in claim 4 wherein said acoustic technology includes at least one of surface acoustic wave technology, ultrasonic technology and free-space acoustic technology.

7. An apparatus for effecting surveillance of a space beyond a barrier as recited in claim 4 wherein said electromagnetic technology includes at least one of radio frequency ultra-wideband technology and terahertz technology.

8. An apparatus for effecting surveillance of a space beyond a barrier as recited in claim 4 wherein said x-ray technology includes x-ray backscatter technology.

9. An apparatus for effecting surveillance of a space beyond a barrier as recited in claim 1 wherein said at least one displayed signal is effected using at least one signal treating technology among synthetic aperture radar technology, inverse synthetic aperture radar technology, waveform stacking technology, amplitude stacking technology and interferometry technology.

10. An apparatus for effecting surveillance of a space beyond a barrier as recited in claim 1 wherein at least two sensor devices of said plurality of sensor devices operate substantially simultaneously.

11. An apparatus for effecting surveillance of a space beyond a barrier as recited in claim 1 wherein at least two sensor devices of said plurality of sensor devices operate in substantially time-interleaved cooperation.

12. An apparatus for effecting surveillance of a space beyond a barrier as recited in claim 1 wherein the apparatus further comprises a selector unit; said selector unit coordinating operation of said plurality of sensor devices to employ capabilities of at least one selected sensor device of said plurality of sensor devices to display said at least one displayed signal.

13. An apparatus for effecting surveillance of a space beyond a barrier as recited in claim 12 wherein said selector unit is controlled by a user of the apparatus.

14. An apparatus for effecting surveillance of a space beyond a barrier as recited in claim 12 wherein said selector unit responds to at least one operational parameter of the apparatus for effecting said coordinating operation of said plurality of sensor devices; said at least one operational parameter indicating an extant environment of the apparatus.

15. An apparatus for effecting surveillance of a space beyond a barrier as recited in claim 1 wherein said cooperating includes algorithmically weighting signals from each said respective sensor according to one or more of reliability of signals from each said respective sensor, signal strength of signals from each said respective signal, quality of each said respective signal and continuity of signals from each said respective signal.

16. An apparatus for effecting surveillance of a space beyond a barrier as recited in claim 15 wherein said weighting is controlled by a user of the apparatus.

17. An apparatus for effecting surveillance of a space beyond a barrier as recited in claim 15 wherein said apparatus includes an information entering unit and wherein said weighting is affected by a user of the apparatus entering information into said information entering unit; said information relating to an extant environment of the apparatus.

18. An apparatus for effecting surveillance of a space beyond a barrier as recited in claim 1 wherein the apparatus is configured for hand-held operation by an operator.

19. An apparatus for effecting surveillance of a space beyond a barrier as recited in claim 1 wherein said at least one displayed signal is one displayed signal; said one displayed signal including information from each said respective sensor signal.

20. An apparatus for effecting surveillance of a space beyond a barrier as recited in claim 1 wherein said at least one display is a plurality of display units; each respective display unit of said plurality of display units displaying a respective said displayed signal representing at least one said respective sensor signal.

21. An apparatus for effecting surveillance of a space beyond a barrier as recited in claim 1 wherein at least one sensor device of said plurality of sensor devices is integrally housed with said display unit.

22. An apparatus for effecting surveillance of a space beyond a barrier as recited in claim 1 wherein said plurality of sensor devices includes at least one passive acoustic sensor device.

23. An apparatus for effecting surveillance of a space beyond a barrier as recited in claim 22 wherein said at least one passive acoustic device includes a plurality of acoustic receivers; said plurality of acoustic receivers being configured for arrangement substantially abutting said barrier.

24. An apparatus for effecting surveillance of a space beyond a barrier as recited in claim 23 wherein said combining unit and said display unit cooperate to correlatingly process received sensor signals from selected acoustic receivers of said plurality of acoustic receivers to display location of a sound source situated in said space.

25. An apparatus for effecting surveillance of a space beyond a barrier as recited in claim 22 wherein at least one said passive acoustic sensor device is configured for providing information in a sensor signal relating to at least one differentiating voice characteristic.

26. An apparatus for effecting surveillance of a space beyond a barrier as recited in claim 24 wherein at least one said passive acoustic sensor device is configured for providing information in a sensor signal relating to at least one differentiating voice characteristic; said information relating to at least one differentiating voice characteristic being employed to differentiate a particular said sound source among a plurality of said sound sources.

27. An apparatus for locating objects beyond a barrier; the apparatus comprising:
(a) at least one sensor device; and
(b) a display unit coupled with said at least one sensor device;
said display unit receiving a respective sensor signal from each respective sensor device of said at least one sensor device; each said respective sensor signal indicating a sensed condition in said space; said display unit displaying at least one displayed signal representing at least one of said respective sensor signals.

28. An apparatus for locating objects beyond a barrier as recited in claim 27 wherein said at least one sensor device includes at least one passive acoustic sensor device.

29. An apparatus for locating objects beyond a barrier as recited in claim 28 wherein said at least one passive acoustic device includes a plurality of acoustic receivers; said plurality of acoustic receivers being configured for arrangement substantially abutting said barrier.

30. An apparatus for locating objects beyond a barrier as recited in claim 29 wherein said display unit correlatingly processes received sensor signals from selected acoustic receivers of said plurality of acoustic receivers to display location of a sound source situated beyond said barrier.

31. An apparatus for locating objects beyond a barrier as recited in claim 28 wherein at least one said passive acoustic sensor device is configured for providing information in a sensor signal relating to at least one differentiating voice characteristic.

32. An apparatus for locating objects beyond a barrier as recited in claim 30 wherein at least one said passive acoustic sensor device is configured for providing information in a sensor signal relating to at least one differentiating voice characteristic; said information relating to at least one differentiating voice characteristic being employed to differentiate a particular said sound source among a plurality of said sound sources.
